(19) United States
(12) Patent Application Publication
(10) Pub. No.: US 2012/0027573 A1
(43) Pub. Date: Feb. 2, 2012

(54) SEAL TEETH FOR SEAL ASSEMBLY

(75) Inventors: Sulficker Ali, Bangalore (IN); Bhaskar Mani, Bangalore (IN); Vasanth Muralidharan, Bangalore (IN); Vishwas Kumar Pandey, Bangalore (IN); Upendra Prabhu Nath Vemula Gopinath, Bangalore (IN)

(73) Assignee: GENERAL ELECTRIC COMPANY, Schenectady, NY (US)

(21) Appl. No.: 12/848,707

(22) Filed: Aug. 2, 2010

(51) Int. Cl. F01D 11/08; F16J 15/16

(52) U.S. Cl. 415/173.1; 277/361

(57) ABSTRACT

In an embodiment, a seal assembly for a rotating element is disclosed. The seal assembly includes: a plurality of arcuate packing rings configured to form an annulus proximately surrounding the rotating element; and a plurality of radially and circumferentially extending seal teeth coupled to each of the plurality of arcuate packing rings, wherein at least one of the plurality of seal teeth includes a plurality of axially extending protrusions.

### BACKGROUND OF THE INVENTION

The present invention relates generally to a seal assembly, and more particularly to a seal assembly including seal teeth having protrusions to reduce swirl and leakage in rotary machines.

Ideally, a rotary machine, such as a turbine, consists of a rotating component positioned within a stationary component. The fluid path inside the rotary machine consists of a primary fluid path and a secondary fluid path. Fluid leakage, either into the primary fluid path from the secondary fluid path or out of the primary fluid path into the secondary fluid path, may adversely affect the operating efficiency of the turbine. In order to minimize leakage, seal assemblies, such as labyrinth seals, typically including arcuate packing rings, are placed between the stationary component and the rotary components of the turbine.

These labyrinth seals conventionally include a plurality of axially spaced, circumferentially extending seal teeth that are used to reduce leakage in the rotary machine.

In operation, with high rotor rotational velocity, fluid axially entering the fluid path of a rotary machine can acquire a significant tangential velocity component (also called “steam swirl”). For example, as the fluid moves through the labyrinth seal, the fluid may flow between the axially spaced seal teeth and circumferentially around the rotating component. This causes the fluid to acquire the significant tangential velocity component, which can induce rotor instabilities in turbomachines. The magnitude of this rotor instability is a function of the circumferential flow component of fluid within the labyrinth seal.

### BRIEF DESCRIPTION OF THE INVENTION

A first aspect of the invention provides a seal assembly for a rotating element, the seal assembly comprising: a plurality of arcuate packing rings configured to form an annulus proximately surrounding the rotating element; and a plurality of radially and circumferentially extending seal teeth coupled to each of the plurality of arcuate packing rings, wherein at least one of the plurality of seal teeth includes a plurality of axially extending protrusions.

A second aspect of the invention provides a turbomachine comprising: a rotating element; a stationary component substantially surrounding the rotating element; and a seal assembly coupled to the stationary component, the seal assembly including: a plurality of arcuate packing rings configured to form an annulus proximately surrounding the rotating element; and a plurality of radially and circumferentially extending seal teeth coupled to each of the plurality of arcuate packing rings, wherein at least one of the plurality of seal teeth includes a plurality of axially extending protrusions.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a partial cross-sectional view of machine according to an embodiment of the invention.

FIG. 2 shows a partial perspective view of a seal assembly according to an embodiment of the invention.

FIG. 3 shows a partial cross-sectional view of a seal assembly according to an embodiment of the invention.

FIG. 4 shows a partial perspective view of a seal assembly according to an embodiment of the invention.

FIG. 5 shows a partial perspective view of a seal assembly according to an embodiment of the invention.

FIG. 6 shows a partial perspective view of a seal assembly according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

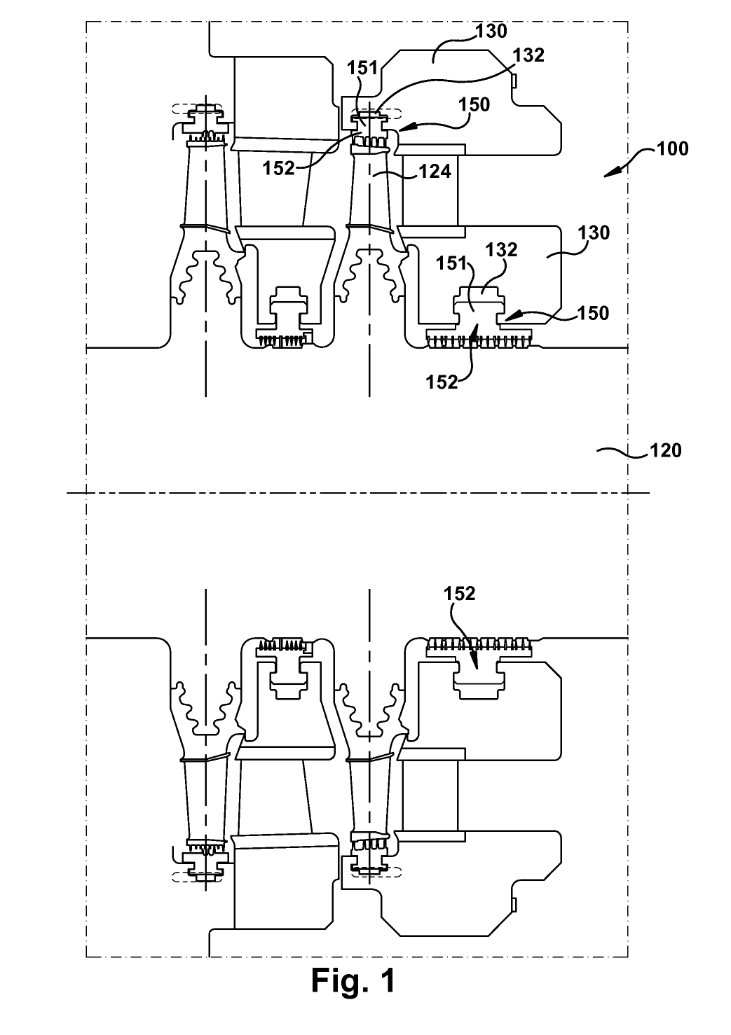

Turning to FIG. 1, a partial cross-sectional view of a machine 100 according to an embodiment of the invention is shown. Although FIGS. 1-6 are shown with respect to a steam turbine, it is understood that the teachings of the various embodiments of the invention may be similarly applied to other turbomachines and that a steam turbine is merely used as an example of one type of turbomachine to describe the aspects of the invention.

Machine 100 may include a rotating element 120 and a stationary component 130. Stationary component 130 may substantially surround rotating element 120. Machine 100 may also include a seal assembly 150 coupled to stationary component 130. As shown, seal assembly 150 may be coupled to stationary component 130 by fitting a mounting portion 151 of an arcuate packing ring 152 within a groove 132 of stationary component 130.

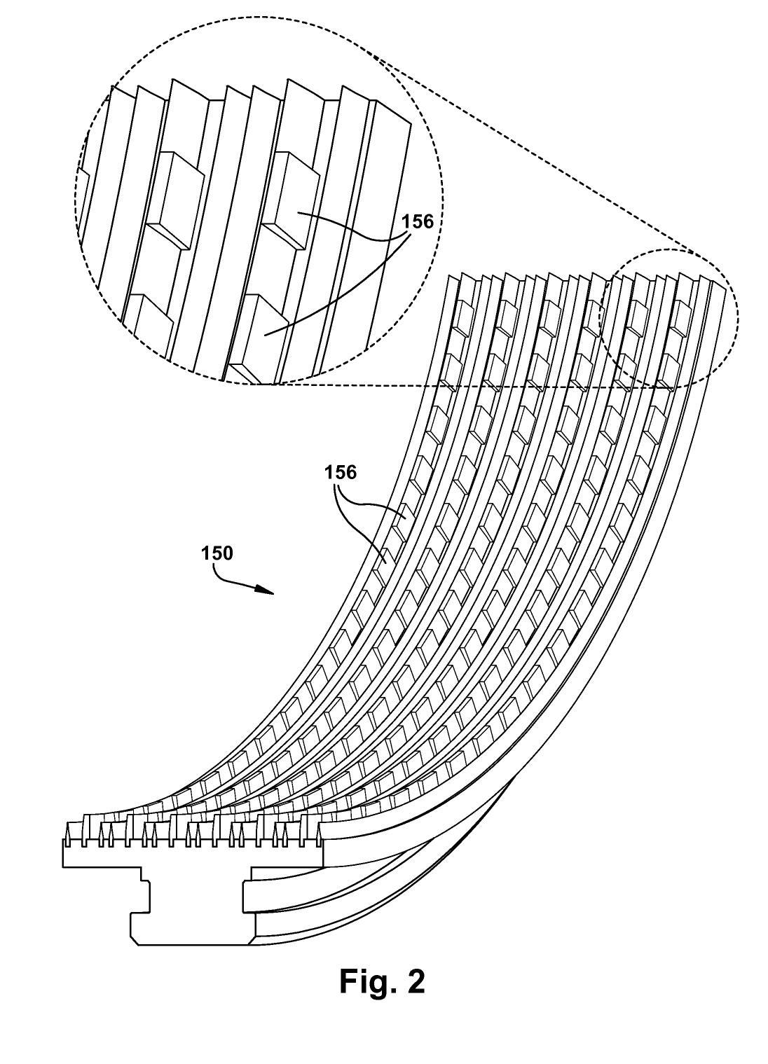

Referring now to FIG. 2, partial perspective view of a seal assembly 150 according to an embodiment of the invention is shown. Seal assembly 150 may include a plurality of arcuate packing rings 152 (only one shown). Arcuate packing rings 152 may be configured to form an annulus that proximately surrounds rotating element 120 (FIG. 1). Seal assembly 150 may include a plurality of seal teeth 154 coupled to each arcuate packing ring 152. Plurality of seal teeth 154 may be coupled to each arcuate packing ring 152 according to any now known or later developed manner, such as, but not limited to, embedded, caulked, or machined. Plurality of seal teeth 154 may extend in a radial direction towards rotating element 120 (FIG. 1) and also in a circumferential direction around rotating element 120 (FIG. 1), such that plurality of seal teeth 154 may seal against flow leakage that may be present along machine 100 (FIG. 1). At least one seal tooth 155 of plurality of seal teeth 154 may include a plurality of protrusions 156 that extend along seal tooth 155 in the axial direction of rotating element 120 (FIG. 1) in order to reduce the rotor induced swirl and leakage between each of the plurality of seal teeth 154, circumferentially around rotating element 120 (FIG. 1), such that at least one seal tooth 155 is profiled.

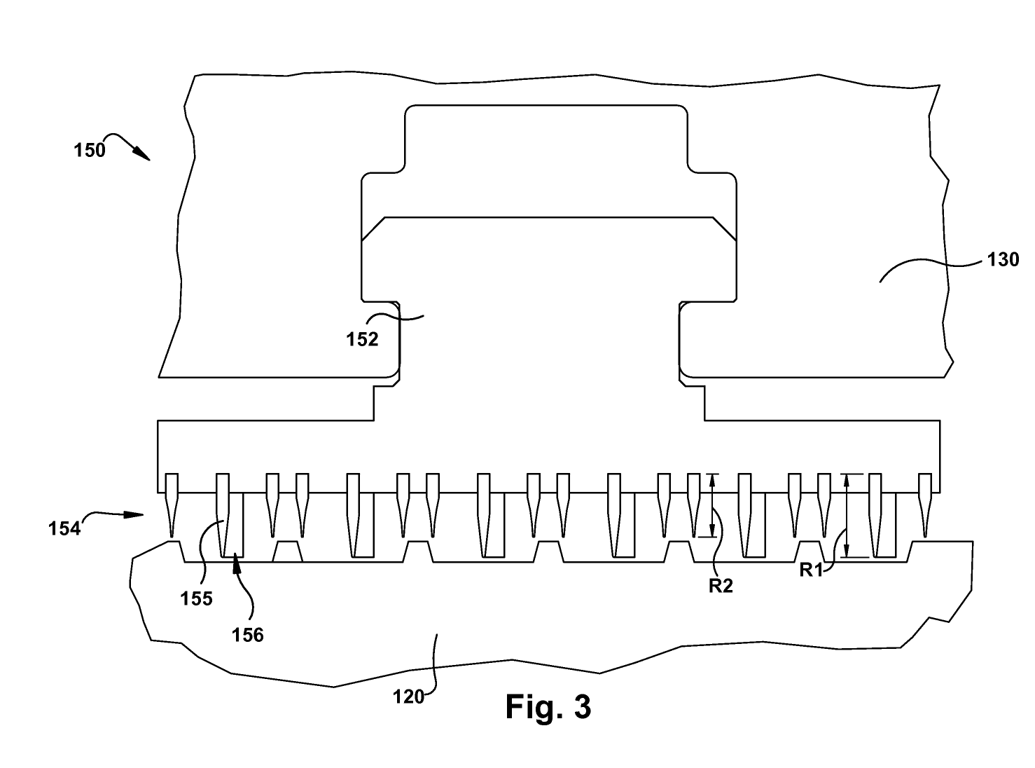

Referring now to FIG. 3, a cross-sectional view of seal assembly 150 according to an embodiment of the invention is shown. Each seal tooth of plurality of seal teeth 154 may extend to either a first radial height (R1) or a second radial height (R2) in the radial direction towards rotating element 120. First radial height (R1) may be greater than second radial height (R2), such that plurality of seal teeth 154 form a hi/lo seal teeth configuration. Alternatively, R1 and R2 may be of the same radial height. At least one seal tooth 155 of plurality of seal teeth 154 may include a plurality of protrusions 156 that extend along seal tooth 155 in the axial direction of rotating element 120 in order to reduce the rotor induced swirl and leakage between each of the plurality of seal teeth 154, circumferentially around rotating element 120. At least one seal tooth 155 that includes plurality of protrusions 156 may include first radial height (R1). As shown in FIG. 3, each seal teeth 154 that includes first radial height (R1) may include plurality of axially extending protrusions 156.

Although plurality of protrusions 156 are shown to extend in one axial direction of rotating element 120 (towards the right in FIG. 3), it is understood that plurality of protrusions 156 may extend in the opposite axial direction of rotating element 120 (towards the left in FIG. 3). Alternatively, plurality of protrusions 156 may extend in both axial directions of rotating element 120 (towards the right and the left in FIG. 3) in an alternating pattern.

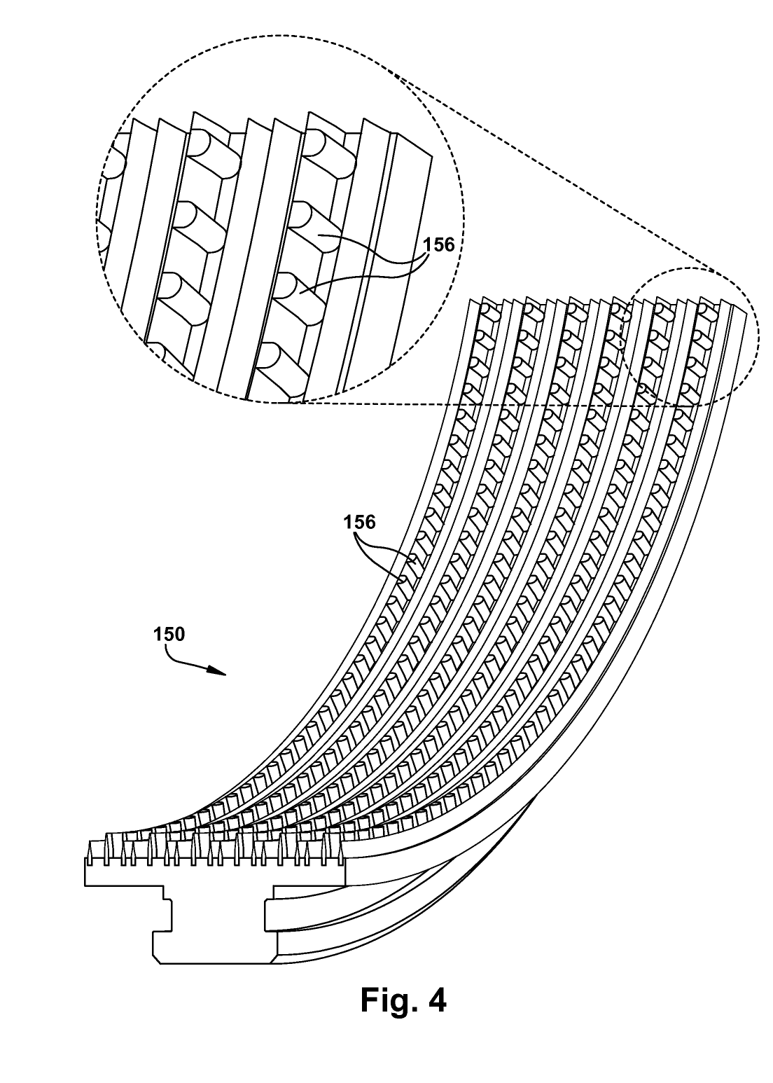

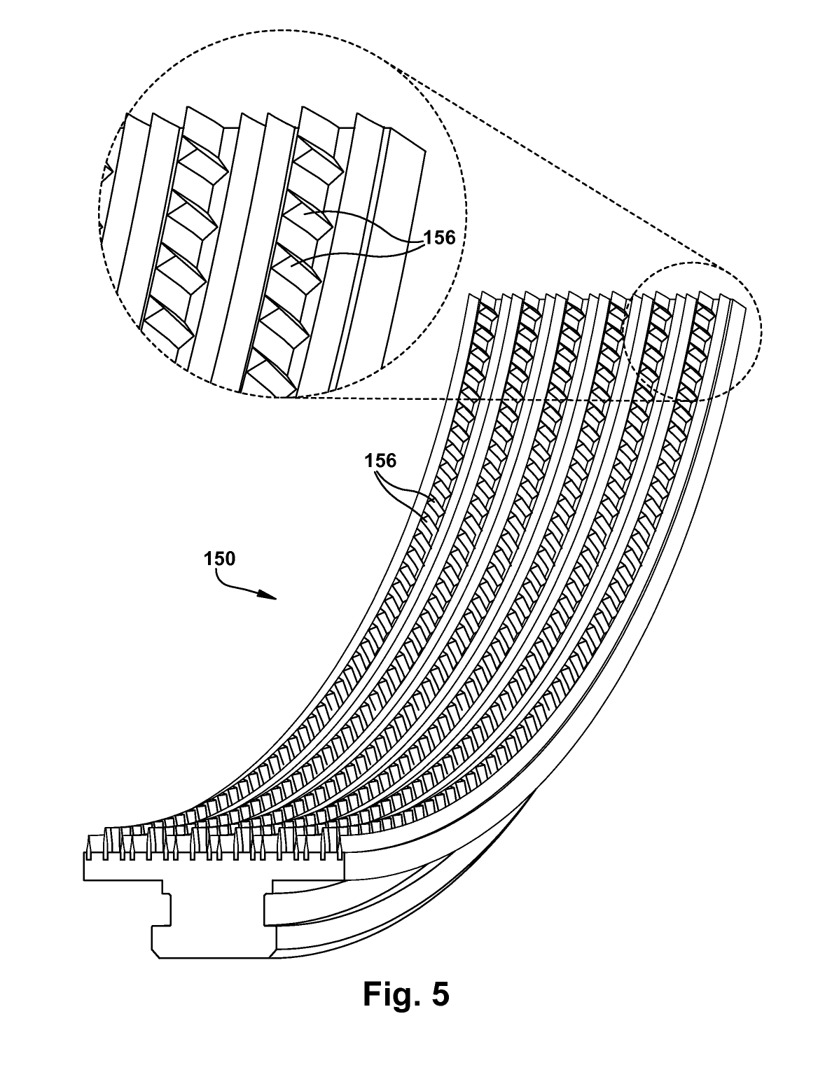

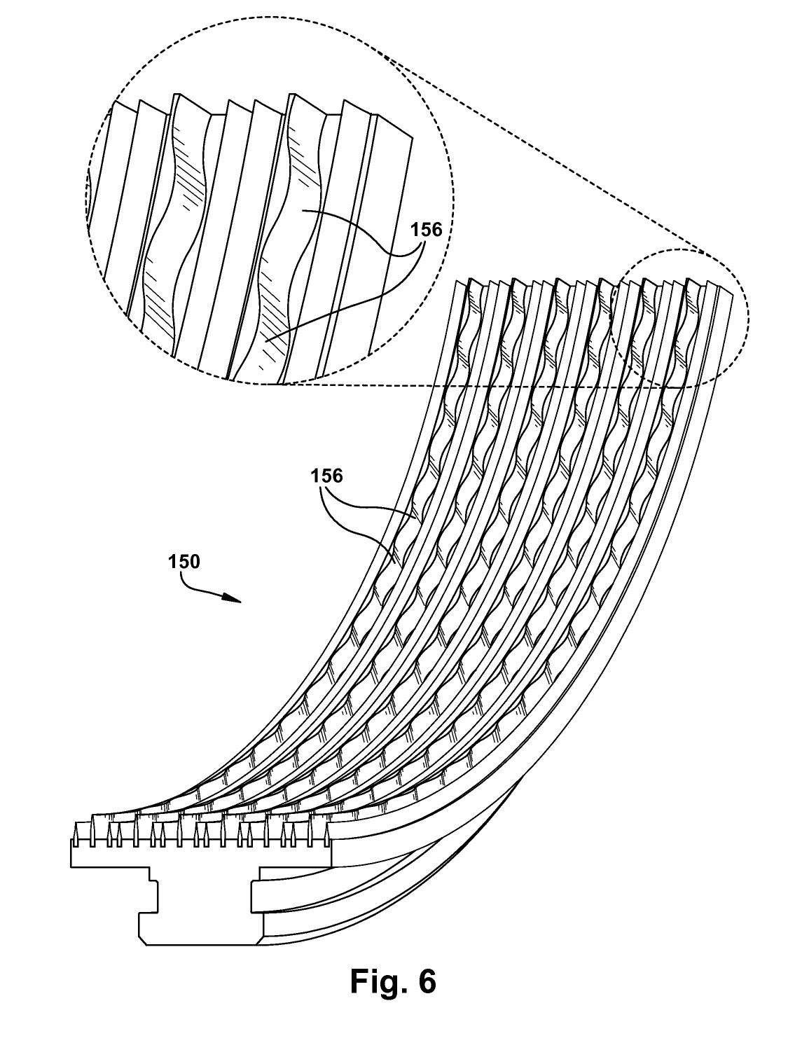

Plurality of axially extending protrusions 156 may be configured to be any shape that prevents fluid from circumferentially flowing, between each of the plurality of seal teeth 154, around rotating element 120. As shown in FIGS. 2-3, plurality of axially extending protrusions 156 may be a substantially square shape. However, plurality of axially extending protrusions 156 may also be substantially semi-circular shape (FIG. 4) or a substantially triangular shape (FIG. 5). Further, plurality of axially extending protrusions 156 may form a substantially continuous sinusoidal surface (FIG. 6), such as a waveform. Although plurality of axially extending protrusions 156 are shown as substantially continuous, it is understood that the sinusoidal surface may be intermittent. Alternatively, plurality of axially extending protrusions 156 may include a combination of different shapes.

As mentioned above, seal assembly 150 may be configured to form an annulus that proximately surrounds rotating element 120. Referring back to FIG. 1, seal assembly 150 may proximately surround any portion of rotating element 120 that requires leakage prevention and swirl reduction. For example, seal assembly 150 may proximately surround rotor 120. Alternatively, seal assembly 150 may proximately surround bucket assembly 124 to reduce bucket tip leakage and swirl.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the various embodiments of the present invention, including the best mode, and also to enable any person skilled in the art to practice the invention, including making and using any devices or systems and performing any incorporated methods. The patentable scope of the various embodiments of the present invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A seal assembly for a rotating element, the seal assembly comprising:
a plurality of arcuate packing rings configured to form an annulus proximately surrounding the rotating element; and
a plurality of radially and circumferentially extending seal teeth coupled to each of the plurality of arcuate packing rings, wherein at least one of the plurality of seal teeth includes a plurality of axially extending protrusions.

2. The seal assembly of claim 1, wherein each of the plurality of radially and circumferentially extending seal teeth include either a first radial height or a second radial height, wherein the first radial height is greater than the second radial height.

3. The seal assembly of claim 2, wherein the at least one of the plurality of radially and circumferentially extending seal teeth including the plurality of axially extending protrusions includes the first radial height.

4. The seal assembly of claim 2, wherein each of the plurality of radially and circumferentially extending seal teeth including the first radial height include a plurality of axially extending protrusions.

5. The seal assembly of claim 1, wherein the plurality of axially extending protrusions are substantially semi-circular.

6. The seal assembly of claim 1, wherein the plurality of axially extending protrusions are substantially triangular.

7. The seal assembly of claim 1, wherein the plurality of axially extending protrusions are substantially square.

8. The seal assembly of claim 1, wherein the plurality of axially extending protrusions form a substantially continuous sinusoidal surface.

9. The seal assembly of claim 1, wherein the rotating element is a rotor.

10. The seal assembly of claim 1, wherein the rotating element is a bucket assembly.

11. A turbomachine comprising:
a rotating element;
a stationary component substantially surrounding the rotating element; and
a seal assembly coupled to the stationary component, the seal assembly including:
a plurality of arcuate packing rings configured to form an annulus proximately surrounding the rotating element; and
a plurality of radially and circumferentially extending seal teeth coupled to each of the plurality of arcuate packing rings, wherein at least one of the plurality of seal teeth includes a plurality of axially extending protrusions.

12. The turbomachine of claim 11, wherein each of the plurality of radially and circumferentially extending seal teeth include either a first radial height or a second radial height, wherein the first radial height is greater than the second radial height.

13. The turbomachine of claim 12, wherein the at least one of the plurality of radially and circumferentially extending seal teeth including the plurality of axially extending protrusions includes the first radial height.

14. The turbomachine of claim 12, wherein each of the plurality of radially and circumferentially extending seal teeth including the first radial height include a plurality of axially extending protrusions.

15. The turbomachine of claim 11, wherein the plurality of axially extending protrusions are substantially semi-circular.

16. The turbomachine of claim 11, wherein the plurality of axially extending protrusions are substantially triangular.

17. The turbomachine of claim 11, wherein the plurality of axially extending protrusions are substantially square.

18. The turbomachine of claim 11, wherein the plurality of axially extending protrusions form a substantially continuous sinusoidal surface.

19. The turbomachine of claim 11, wherein the seal assembly proximately surrounds a rotor.

20. The turbomachine of claim 11, wherein the seal assembly proximately surrounds a bucket assembly.
